(19) United States
(12) Patent Application Publication
(10) Pub. No.: US 2015/0237422 A1
(43) Pub. Date: Aug. 20, 2015

(54) ELECTROLARYNX

(71) Applicant: CLIFFORD JAY GRIFFIN, Temecula, CA (US)

(72) Inventor: CLIFFORD JAY GRIFFIN, Temecula, CA (US)

(21) Appl. No.: 13/663,185

(22) Filed: Oct. 29, 2012

(51) Int. Cl. H04R 1/00

(52) U.S. Cl. CPC H04R 1/00

(57) ABSTRACT

An electrolarynx includes a case, a tone-producing diaphragm on a forward portion of the case, and a radially extending member circumscribing the diaphragm for holding the diaphragm on the forward portion so that the diaphragm is free to vibrate and produce an electrolarynx tone in response to a diaphragm-driving subassembly in the case. The radially extending member is composed of an elastomer (preferably silicone rubber) for improved sound while being less prone to collect dead skin, soil, saliva, food particles, and the like compared to foam counterparts. One such member is part of a diaphragm-holding ring disposed between the diaphragm and the forward portion of the case, while another is formed integrally with the forward portion, preferably having a thickness in a range of about 0.010 inches to about 0.060 inches.

### BACKGROUND OF THE INVENTION

1. Technical Field

[01.00] This invention relates generally to electrolarynx devices and other such apparatuses that enable a laryngectomized person to produce speech. More particularly, it relates to an improved electrolarynx construction that significantly improves electrolarynx operation while reducing fabrication time and expense.

2. Description of Related Art

“Larynx” refers to the portion of a person's respiratory tract containing the vocal cords that produce vocal sound. The person moves their organs of articulation (i.e., the tongue, teeth, lips, and glottis) to modulate that vocal sound and thereby produce recognizable speech. However, a laryngectomized person, or other person without normal use of their vocal cords or larynx, must produce the required vocal sound by other means. They often use a handheld, battery-powered, electrolarynx for that purpose.

An electrolarynx is sometimes referred to as an “electronic speech aid” or as an “electronic artificial larynx.” It may have a size and shape similar to a small handheld flashlight, and it produces a tone at a forward end that has a fundamental frequency in the speech range of the average human voice (e.g., a buzzing sound). The laryngectomee (or other user) introduces that tone into a resonant speech cavity (i.e., the mouth, nose, or pharynx of the user) as the required vocal sound by pressing the tone-producing forward end against their throat or other body part. As that is done, they modulate the electrolarynx-produced vocal sound with the usual constrictions of the tongue, teeth, lips and glottis to produce simulated speech.

The foregoing electrolarynx communication technique is well known and commonly used, and U.S. Pat. Nos. 5,812,681 and 6,252,966 issued to Clifford J. Griffin describe various details of some existing electrolarynx devices available from Griffin Laboratories of Temecula, Calif. As described in those patents, a typical electrolarynx device may include, for example, a four-inch to five-inch long, cylindrically shaped, plastic case that houses an assembly of electronic components that produce the electrolarynx tone, although some cases are smaller and some are larger. A battery-powered electronic circuit on a printed circuit board within the case includes an electro-mechanical transducer that drives a button-like diaphragm (i.e., a tone-producing diaphragm) on a forward end of the case to produce vibrations (i.e., the electrolarynx tone). The user grasps the case in one hand, or with suitable case-holding structure, depresses a control button, sets a volume control wheel to a desired level, and presses the diaphragm against the outside of their throat so that vibrations travel from the diaphragm, through the throat tissues, and into the mouth and throat as the required vocal sound that the user modulates to produce the simulated speech.

In enabling a person to produce simulated speech that way, electrolarynx devices have become important communication aids that enjoy significant commercial success. One user concern, however, is that sound quality may be less than desired and it often varies from unit to unit. The volume and/or pitch and/or other tonal qualities vary inexplicably from unit to unit despite the common construction. Users may have decided to purchase a specific electrolarynx model, but they nevertheless find it necessary to open the packaging and operate a unit before purchase in order to identify one with desired volume and pitch audio characteristics. That activity can translate to cost, inconvenience, displeased customers, and potentially unhappy users. Thus, a need exists for a way to alleviate this concern.

### SUMMARY OF THE INVENTION

In view of the foregoing, it is an object of the present invention to provide an electrolarynx device having improved audio characteristics that are consistent from unit to unit while avoiding major design changes and cost consequences. The present invention achieves this objective predicated on the inventor's discovery and appreciation of the significant performance-degrading effects of some existing electrolarynx diaphragm mountings, followed by the inventor's conception of an electrolarynx diaphragm mounting that avoids those effects. More specifically, some existing diaphragm mountings use a diaphragm-supporting ring composed of foam. The inventor discovered that such a foam ring can degrade audio characteristics. The inventor then conceived and implemented the present invention in the form of an electrolarynx having a diaphragm-supporting ring composed of a non-foam elastomer, an elastic material (preferably silicone rubber) instead of the usual foam material. In addition, the ring is relatively thin so that it does not significantly dampen axially movement of the diaphragm. That construction results in significantly improved audio characteristics that remain more consistent from unit to unit.

Unlike a foam ring, a diaphragm-supporting ring composed of silicone rubber is more readily manufactured. It is easily stamped into a desired configuration. It exhibits more consistent thickness and density than foam, thereby providing more consistent performance-affecting characteristics from one batch to another for better repeatability. It can be made waterproof. In operation, it yields more favorably to the diaphragm movement produced by sound-transducer pressure. It does not dampen movement like a foam ring. Sound and diaphragm movement is not absorbed or dampened as with a prior art foam ring, thereby resulting in greater efficiency of sound transfer to the person speaking with the device. Audio seems louder and tonal quality improved. Moreover, the silicone rubber diaphragm does not become packed with particles that may otherwise accumulate during normal use (e.g., dead skin, soil, saliva, food particles, etc.).

To paraphrase some of the more precise language appearing in the claims and further introduce the nomenclature used, an electrolarynx constructed according to the invention includes a case, a tone-producing diaphragm on a forward portion of the case, and a radially extending member circumscribing the diaphragm for holding the diaphragm on the forward portion so that the diaphragm is free to vibrate and produce an electrolarynx tone in response to a diaphragm-driving subassembly in the case. The radially extending member is composed of an elastomer (preferably silicone rubber) for improved sound while being less prone to collect dead skin, soil, saliva, food particles, and the like compared to foam counterparts. One such radially extending member is part of a diaphragm-holding ring disposed between the diaphragm and the forward portion of the case, while another is formed integrally with the forward portion, preferably having a thickness in a range of about 0.010 inches to about 0.060 inches. One retrofitting embodiment of the diaphragm-holding ring is shaped and dimensioned to replace the foam ring of a prior art electrolarynx design. The prior art primarily uses compressive material while the present invention uses elastic material, and it does so in a way that facilitates axial movement of the diaphragm for better tonal qualities.

Thus, the invention provides an electrolarynx device having improved audio characteristics that are consistent from unit to unit while avoiding major design changes and cost consequences. The following detailed description and accompanying illustrative drawings make the foregoing and other objects, features, and advantages of the invention more apparent.

### BRIEF DESCRIPTION OF THE DRAWINGS

FIG. 1 of the drawings is a perspective view of an electrolarynx constructed according to the present invention;

FIG. 2 of the drawings is an enlarged elevation view of an electrolarynx constructed according to the prior art, with the forward portion shown in cross section;

FIG. 3 is an enlarged perspective view of a first embodiment of a diaphragm-holding ring constructed according to the present invention, showing its forwardly facing side;

FIG. 4 is an enlarged perspective view of an alternate second embodiment of a diaphragm-holding ring constructed according to the invention, showing its forwardly facing side;

FIG. 5 is an enlarged perspective view of the second diaphragm-holding ring embodiment showing its rearwardly facing side;

FIG. 6 is an enlarged cross sectional view of the forward portion of the electrolarynx shown in FIG. 1, with the diaphragm, the first diaphragm-holding ring embodiment, and the retainer ring omitted for illustrative purposes;

FIG. 7 is an enlarged cross sectional view of just the diaphragm;

FIG. 8 is an enlarged cross sectional view of the forward portion of the electrolarynx shown in FIG. 1, with the diaphragm, the first diaphragm-holding ring embodiment, and the retainer ring included;

FIG. 9 is a further enlarged cross sectional view of just the first diaphragm-holding ring embodiment of the present invention;

FIG. 10 is an enlarged cross sectional view of the forward portion of the prior art electrolarynx shown in FIG. 2;

FIG. 11 is an enlarged cross sectional view similar to FIG. 10 of the alternate electrolarynx embodiment, showing its prior art electrolarynx case retrofitted with the alternate second embodiment of the diaphragm-holding ring;

FIG. 12 is a further enlarged cross sectional view similar to FIG. 10 of just the retrofitting second diaphragm-holding a ring embodiment;

FIG. 13a is a cross sectional view of the forward portion of an electrolarynx having a third diaphragm-holding ring embodiment;

FIG. 13b is an enlarged portion of the third diaphragm-holding ring embodiment;

FIG. 14a is an enlarged portion of a fourth diaphragm-holding ring embodiment;

FIG. 14b is an enlarged portion of a fifth diaphragm-holding ring embodiment;

FIG. 15a is a cross sectional view of a sixth diaphragm-holding ring embodiment that features molded one-piece construction of the diaphragm-holding ring and the forward portion of the case;

FIG. 15b is a cross sectional view of a seventh diaphragm-holding ring embodiment having molded one-piece construction for holding a simplified diaphragm;

FIG. 16a is a diagrammatic representation of a prior art diaphragm-holding ring embodiment having molded one-piece construction for holding a diaphragm, but with a relatively thick, and therefore stiff, radially extending third portion that inhibits diaphragm movement; and

FIG. 16b is a cross sectional view of an eighth diaphragm-holding ring embodiment constructed according to the invention in molded one-piece construction similar to FIG. 16a, but with an annular groove that reduces thickness of the radially extending third portion so that it is more flexible and results in improved tonal quality.

### DESCRIPTION OF THE PREFERRED EMBODIMENTS

The following description begins with a brief overview of the exterior of an electrolarynx constructed according to the present invention. Next, there is a description of a prior art electrolarynx and some related concerns. After that, details are provided about several electrolarynx diaphragm-holding ring embodiments constructed according to the present invention—the first embodiment includes a thin disc-shaped diaphragm-holding ring composed of silicone rubber, the second embodiment includes a retrofitted prior art case having a silicone-rubber ring that is shaped to replace a thicker prior art foam ring, and the remaining embodiments illustrate additional variations.

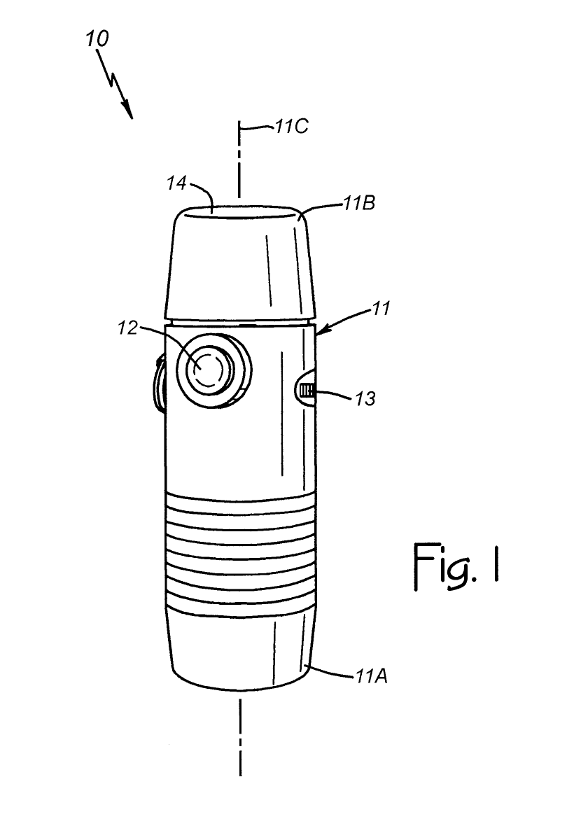

First consider FIG. 1 of the drawings. It shows an electrolarynx 10 constructed according to the present invention. Generally, the electrolarynx 10 includes a case 11 housing battery-powered electronic circuitry (not shown) that produces an electrolarynx tone. The case 11 has a rearward portion 11A, a forward portion 11B, and a central axis of elongation 11C extending centrally through the rearward and forward portions 11A and 11B. The case 11 may, for example, take the form of a four-inch to five-inch long, cylindrically shaped, molded-plastic component. A user (not shown) grasps the case 11 in one hand, or with suitable case-holding structure (not shown), depresses a control button 12, and adjusts a volume control wheel 13 to ready the device for operation. To produce speech, the user presses a tone-producing diaphragm 14 on the forward 11B of the case 11 against their throat while depressing the control button 12 and modulating the electrolarynx tone with the usual constrictions of the tongue, teeth, lips and glottis.

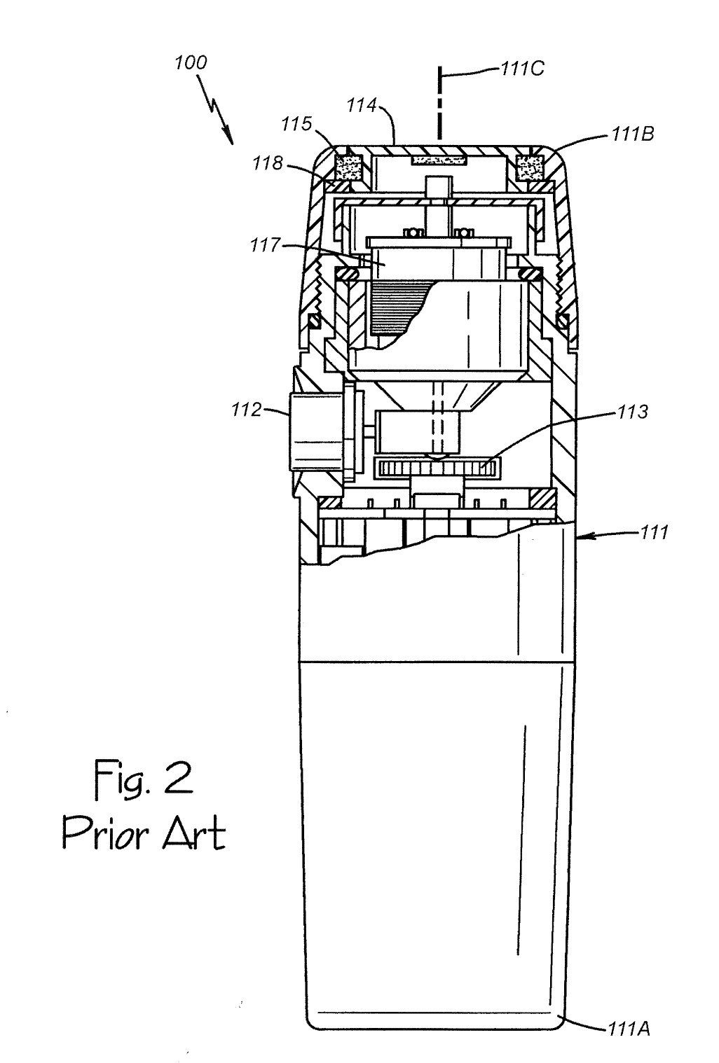

Now consider FIG. 2. It shows an electrolarynx 100 that works in much the same way, but which is constructed according to the prior art. The prior art electrolarynx 100 is similar in many respects to the electrolarynx 10 of the present invention, including a case 111 having a rearward portion 111A, a forward portion 111B, and a central axis of elongation 111C. The case 111 houses electronic circuitry and a battery power supply that the user controls with a control button 112 and volume wheel 113 to vary the electrolarynx tone produced by a tone-producing diaphragm 114. Construction is similar to the artificial larynx described in U.S. Pat. No. 6,252,966. Readers may refer to that patent for additional details of construction.

The cross sectional views of the prior art electrolarynx 100 provided in FIGS. 2 and 10 reveal a tone-producing diaphragm 114 on the forward portion 111B of the case 111 that vibrates in response to mechanical vibrations produced by an electro-mechanical transducer subassembly 117. Depressing the control button 112 causes the electro-mechanical transducer assembly 117 to produce the mechanical vibrations. They are coupled to the diaphragm 114 on the forward portion 111B of the case 111 to produce the desired electrolarynx tone. A prior art diaphragm-holding ring 115 holds the tone-producing diaphragm 114 coaxially within a circularly shaped opening defined by the forward portion 111B. A retainer ring 118 is glued or otherwise suitably bonded to the forward portion 111B of the case 111 where it retains the diaphragm-holding ring 115 in place.

While considering variations in audio quality experienced by some users of the prior art electrolarynx 100, the inventor of the present invention discovered that the prior art diaphragm-holding ring 115 was a significant contributing factor. Composed of foam, the diaphragm-holding ring 115 exhibited characteristics that varied from one electrolarynx unit to another. Different rings had different audio-affecting characteristics. Moreover, the compressible foam of the prior art diaphragm-holding ring 115 could dampen diaphragm movement and thereby affect the electrolarynx tone in an undesirable way.

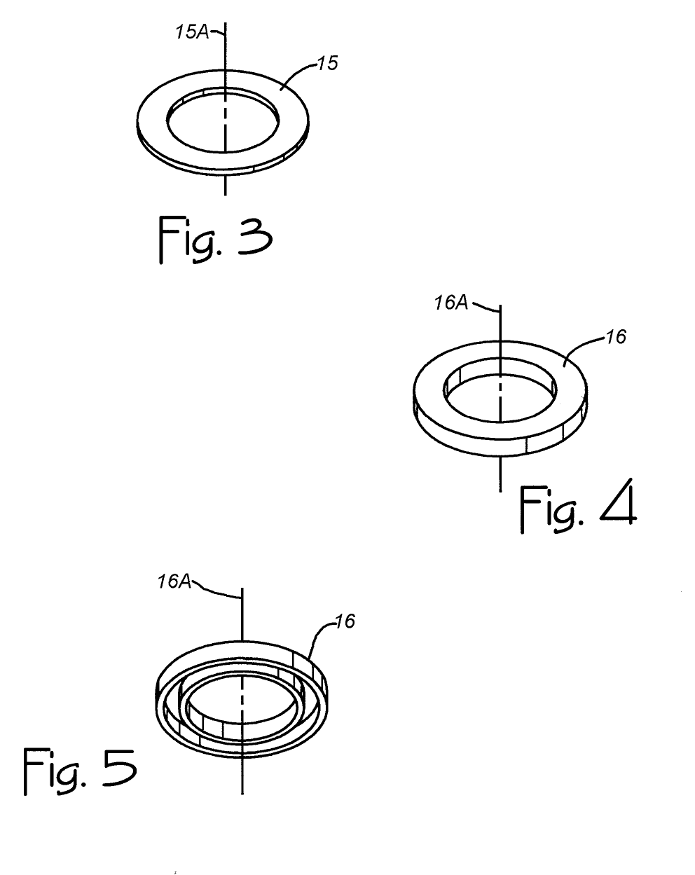

The inventor's conception of a relatively thin diaphragm-holding ring composed of a non-foam elastomer (e.g., silicone rubber) followed the foregoing realizations. Two embodiments of such a diaphragm-holding ring are shown in FIGS. 3, 4, and 5. The first embodiment (i.e., a first diaphragm-holding ring 15 shown in FIG. 3) takes the form of a flat disc of silicone rubber that holds the diaphragm 14 in the forward portion 11B of the case 11 shown in FIG. 1. When the diaphragm-holding ring 15 is assembled in the case 11, a central axis of symmetry 15A of the ring 15 is aligned with the axis of elongation 11C of the case 11. The second embodiment (i.e., a second diaphragm-holding ring 16 illustrated in FIGS. 4 and 5) takes the form of a disc of silicone rubber having thickness-increasing marginal edge portions (e.g., annular rings at the outer and inner marginal edges) that enable use in a prior art electrolarynx case that was designed to receive the thicker prior art diaphragm-holding ring composed of foam. When the diaphragm-holding ring 16 is assembled in the prior art case 111, a central axis of symmetry 16A of the ring 16 is aligned with the axis of elongation 111C of the case 111 as discussed later on in this description. Based upon the foregoing and subsequent descriptions, one of ordinary skill in the art can readily implement an electrolarynx according to the invention using a non-foam elastomer (preferably silicone rubber) diaphragm-holding ring as illustrated, as well as such a ring with a shape other than those described.

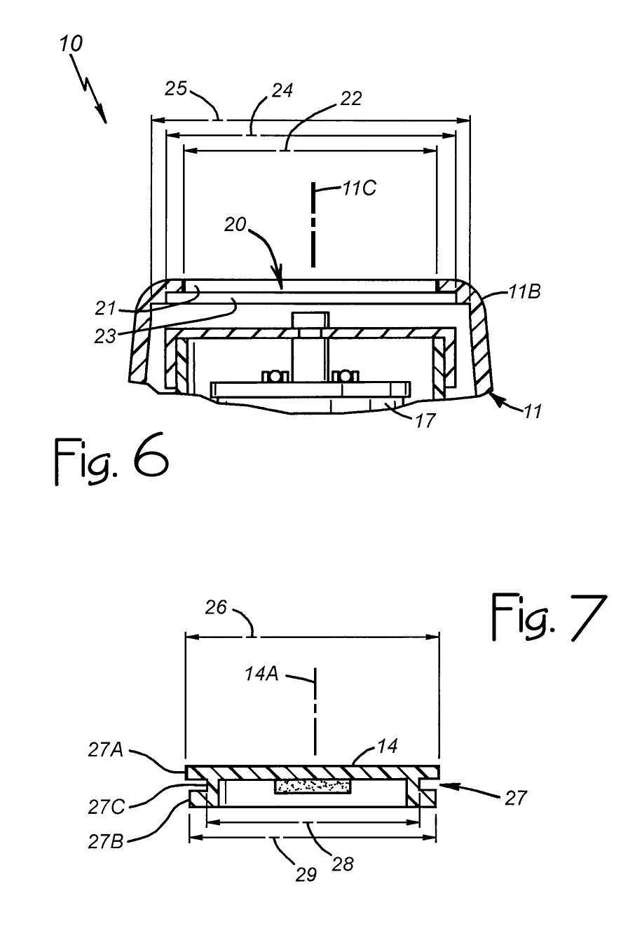

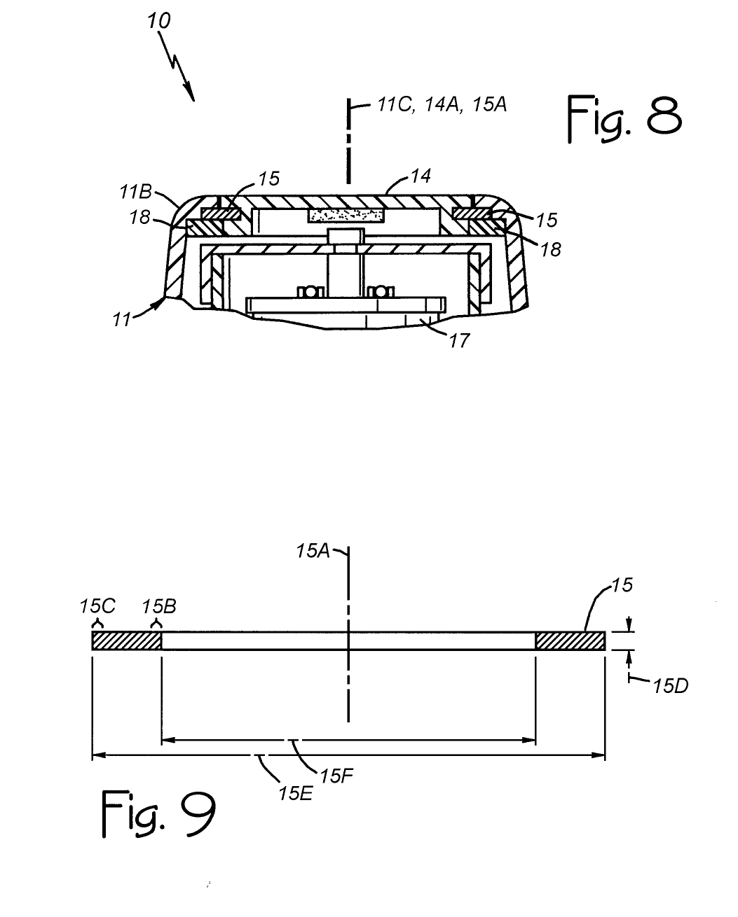

Turning now to FIGS. 6 through 12, they illustrate various details of the diaphragm-holding rings 15 and 16. FIGS. 6 through 9 concern the electrolarynx 10. It is similar in many respects to the prior art electrolarynx 100 described above, including an electro-mechanical transducer assembly 17 (FIGS. 6 and 8) that drives the tone-producing diaphragm 14. The electro-mechanical transducer assembly is also referred to herein as “a diaphragm-driving subassembly disposed at least partially within the case,” while the tone-producing diaphragm 14 is also referred to herein as “a diaphragm on the forward portion of the case that functions as means for producing an electrolarynx tone in response to the mechanical vibrations.” According to the present invention, the electrolarynx 10 includes the silicone rubber first diaphragm-holding ring 15 so that it exhibits the improved audio characteristics resulting from its silicone rubber composition. The diaphragm-holding ring 15 holds the diaphragm 14 (FIGS. 7 and 9) within a circularly shaped, diaphragm-receiving opening 20 in the forward portion 11B of the case 11 (FIG. 6) while a retainer ring 18 (FIG. 8) retains the diaphragm-holding ring 15 in place.

The diaphragm-holding ring 15 is the major difference. Similar in some respects to the diaphragm-holding ring 115, the ring 15 functions as means for holding the diaphragm 14 on the forward portion 14B of the case 11, with the diaphragm 14 mechanically coupled to the diaphragm-driving subassembly 17 and free to move in response to the mechanical vibrations. However, the diaphragm-holding ring 15 is composed of silicone rubber. That construction significantly improves electrolarynx performance while rendering audio characteristics more consistent from one unit to the next. It also results in less tendency to accumulate dead skin, soil, saliva, food, and other particles.

FIG. 6 shows the electrolarynx 10 without the diaphragm 14, the first diaphragm-holding ring 15, and the retainer ring 18. They are omitted for illustrative purposes, in order to better expose the diaphragm-receiving opening 20 defined by the forward portion 11B of the case 11. The opening 20 is defined by a first annular surface 21 having a first inside diameter 22 (e.g., a diameter of about 29/32 inch) into which the circular diaphragm 14 fits, and by a second annular surface 23 having a second inside diameter 24 (e.g., a diameter of about one inch) into which the diaphragm-holding ring 15 fits. The second annular surface 23 is specified in the claims as “a radially inward facing annular surface.” A third diameter 25 of the opening 20 (e.g., a diameter of about 1.0625 inches) receives the retainer ring 18 to secure the ring 15 in place.

FIG. 7 shows just the diaphragm 14. It may take the form of a circularly shaped molded plastic component with a central axis of symmetry 14A. The diaphragm 14 fits into the forward portion 11B of the case 11 (FIG. 8) with the central axis of symmetry 14A of the diaphragm 14 aligned with the central axis of elongation 11C of the case 11. For that purpose, the illustrated diaphragm 14 has a first outside diameter 26 slightly smaller than the first inside diameter 22 of the opening 20. In addition, the diaphragm 14 defines a circumferentially extending annular channel 27 between a radially protruding first outer marginal edge portion 27A, a second radially protruding second marginal edge portion 27B, and a radially outward facing annular surface 27C of the diaphragm 14. The channel 27 receives an inner marginal edge portion 15B of the diaphragm-holding ring 15 that is identified in FIG. 9. The radially outward facing annular surface 27C of the diaphragm 14 (FIG. 7) has a second outside diameter 28 measuring about 0.625 inches. A third outside diameter 29 of the diaphragm 14 fits coaxially and moveably within the retainer ring 18.

FIG. 8 is a cross section view of the forward portion 11B of the case 11 with the diaphragm 14, the diaphragm-holding ring 15, and the retainer ring 18 fully assembled. So assembled, the radially outward facing annular surface 26C of the diaphragm 14 faces the radially inward facing annular surface 23 of the forward portion 11B of the case 11. Also, a central axis of symmetry 15A of the diaphragm-holding ring 15 (identified in FIGS. 8 and 9), and the central axis of symmetry 14A of the diaphragm 14, coincide with the central axis of elongation 11C of the case 11. In addition, an outer marginal edge portion 15C of the diaphragm-holding ring 15 (identified in FIG. 7) is disposed within the second inner diameter 23 of the forward portion 11B (identified in FIG. 6), while an inner marginal edge portion 15B is disposed within the channel 26 of the diaphragm 14. The diaphragm 14 is free to vibrate in response to mechanical vibrations produced by an electro-mechanical transducer subassembly 17, something like operation of the prior art electrolarynx 100, but with advantages of the silicone rubber construction of the diaphragm-holding ring 15.

FIG. 9 is a further enlarged cross sectional view of just the diaphragm-holding ring 15. It is shown centered on a central axis of symmetry 15A. The illustrated ring 15 is stamped from a sheet of silicone rubber having a thickness a range of about 0.010 inches to about 0.080 inches (preferably about 0.040 inches as indicated by a dimension 15D in FIG. 9). That thickness holds the diaphragm 14 on the forward portion 11B without significantly dampening axially movement of the diaphragm 14 parallel to the central axis of elongation 11C; the diaphragm 14 is free to vibrate in response to mechanical vibrations produced by the electro-mechanical transducer assembly 17. The illustrated ring 15 has an outside diameter 15E of about 1.0 inches and an inside diameter 15F of about 0.625 inches. From the foregoing and subsequent descriptions, one of ordinary skill in the art can readily implement a diaphragm-holding ring constructed according to the invention using other elastic materials, fabrication methods, and dimensions.

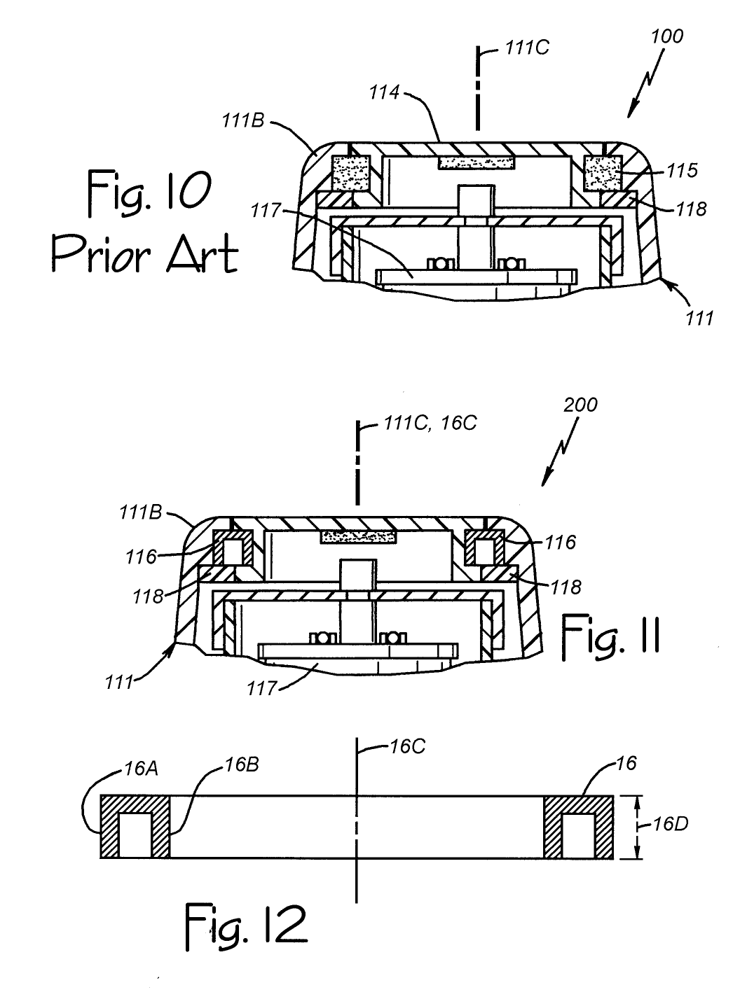

FIGS. 10, 11, and 12 concern the second diaphragm-holding ring embodiment (i.e., the ring 16). FIG. 10 shows an enlarged portion of the prior art electrolarynx 100 that was discussed previously with reference to FIG. 2. It includes the one-inch outer diameter prior art diaphragm-holding ring 115 composed of foam. FIG. 11 shows the case 111 of the prior art electrolarynx 100 after it has been retrofitted with the second embodiment diaphragm-holding ring 16 to form an electrolarynx 200 constructed according to the invention. The ring 16 (e.g., a ring having a one-inch outside diameter and 0.625-inch inside diameter) is used in place of the foam prior art ring 115. The ring 16 includes a circumferentially extending, outer thickness-increasing portion 16A (FIG. 12) that fits the prior art forward portion 111B of the prior art case 111 as shown in FIG. 11. It also includes a circumferentially extending inner thickness-increasing portion 16B (FIG. 12) that fits a channel in the prior art diaphragm 114 (FIG. 11) to thereby enable the ring 16 to replace the prior art diaphragm-holding ring 115 shown in FIG. 10. The outer and inner thickness-increasing portions 16A and 16B result in the ring 16 having an overall thickness 16D (FIG. 12) in a range of about 0.08 inches to about 0.15 inches. The overall thickness is preferably about 0.125 inches, that being the overall thickness of the particular prior art ring 115 in FIG. 10 that the ring 16 replaces. Assembled in the forward portion 111B of the prior art case 111, a central axis of symmetry 16C of the diaphragm-holding ring 16 coincides with the central axis of elongation 111C of the case 111 (FIG. 11).

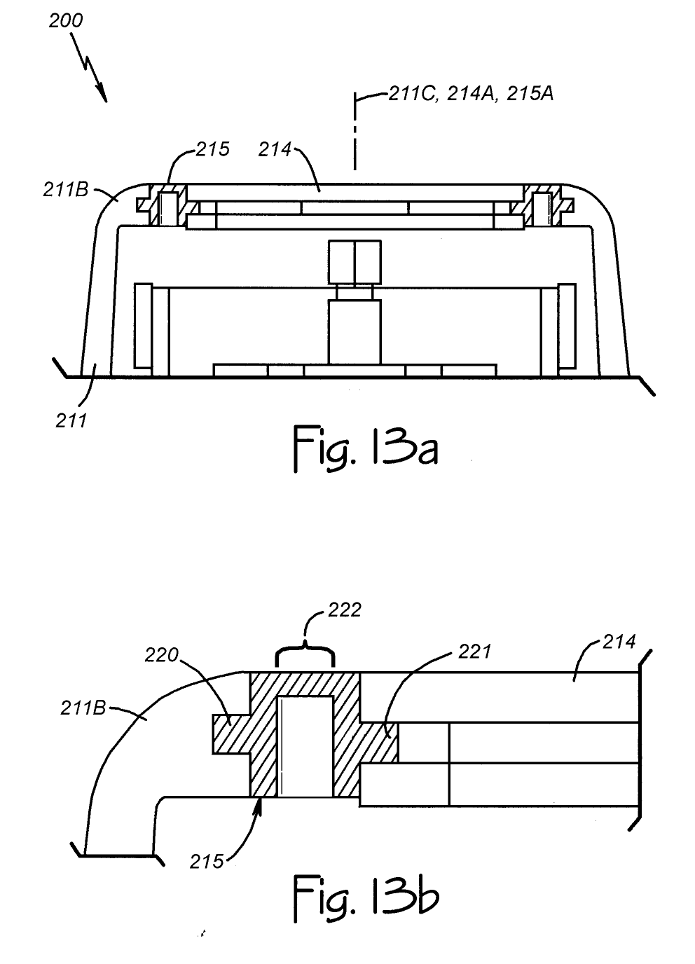

Now consider the electrolarynx 200 and its diaphragm-holding ring 215 as shown in FIGS. 13a and 13b, along with the alternative nomenclature introduced here to identify the various parts. The electrolarynx 200 is similar in many respects to the electrolarynx 10 described previously in this description, and so only differences are considered in further detail. For convenience, reference numerals designation parts of the electrolarynx 200 are increased by two hundred over those designating similar or related parts of the electrolarynx 10.

The electrolarynx 200 includes an electrolarynx case 211 having a forward portion 211B and a central axis of elongation 211C (FIG. 13a). It also includes a tone-producing diaphragm 214 having a central axis of symmetry 214A and a diaphragm-holding ring 215 having a central axis of symmetry 215A. The diaphragm-holding ring 215 has a case-engaging first portion 220, a diaphragm-engaging second portion 221, and a radially extending third portion 222 extending intermediate the first and second portions 220 and 221 that is also referred to as a diaphragm-circumscribing member (i.e., a thin, flexible, interconnecting component that circumscribes the diaphragm between the diaphragm and the forward portion of the case in order to hold the diaphragm moveably on the forward portion of the case (FIG. 13b). The first portion 220 engages the forward portion 211B of the case 211 (i.e., inhibits axially movement of the ring relative to the case) and the second portion engages the diaphragm 214 (i e, inhibits axially movement of the diaphragm relative to the ring), while the third portion 222 cooperates with the first and second portions to hold the diaphragm 214 on the forward portion 211B without significantly dampening diaphragm movement. For that purpose, the radially extending third portion 222 is composed of a non-foam elastomer (e.g., silicone rubber) having a thickness (measured parallel to a central axis of symmetry 215A of the diaphragm-holding ring 215) in a range of about 0.010 inches to about 0.060 inches (preferably about 0.030 inches to about 0.040 inches). The radially extending third portion 222 extends radially between the first and second portions 220 and 221 relative to the coincident central axis of symmetry 214A of the diaphragm 214 and the central axis of elongation 211C of the case 211 that are identified in FIG. 13a. Preferably, the entire diaphragm-holding ring 215 is composed of silicone rubber or other suitable elastomer.

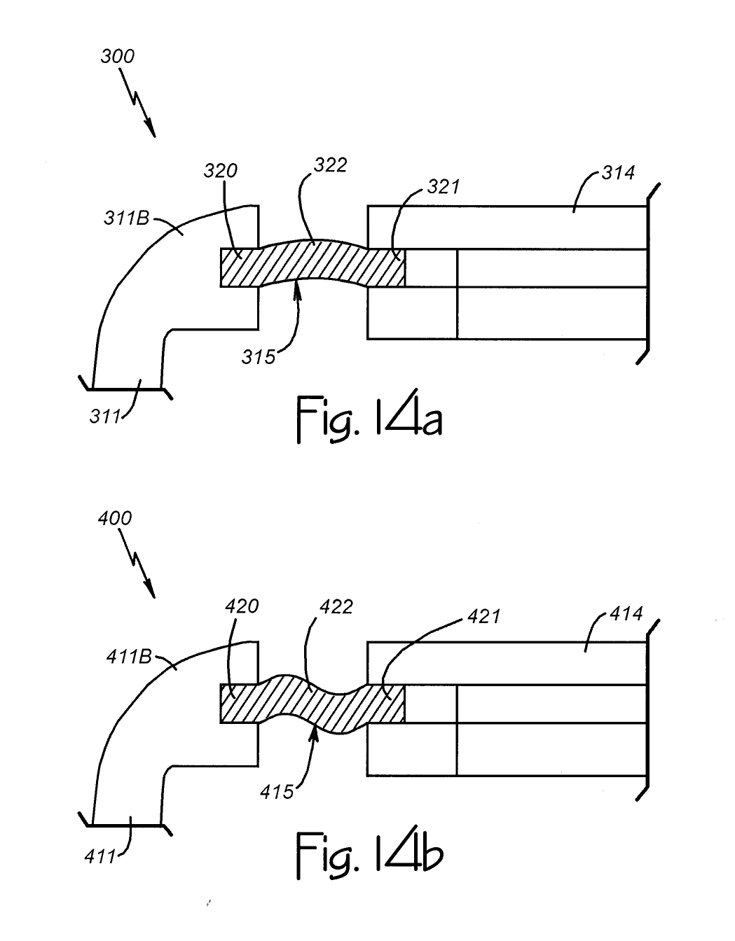

The alternate nomenclature introduced above also applies to an electrolarynx 300 in FIG. 14a. The electrolarynx 300 includes a tone-producing diaphragm 314 held on a forward portion 311B of an electrolarynx case 311 by means of a diaphragm-holding ring 315 having a case-engaging first portion 320, a diaphragm-engaging second portion 321, and a radially extending third portion 322 extending intermediate the first and second portions (i.e., a diaphragm-circumscribing member). The third portion 322 is composed of an elastomer (e.g., silicone rubber) and it has a thickness in a range of about 0.010 inches to about 0.060 inches (preferably about 0.040 inches). In addition, the radially extending third portion 322 is arcuate in that it defines a single wave (i.e., it extends radially between the first and second portions 320 and 321 along an arc). The wave design may be used to advantageously affect physical characteristics of the radially extending third portion 322 in order to thereby achieve a desired improvement in diaphragm vibration.

An electrolarynx 400 in FIG. 14b includes a wave design also. The electrolarynx 400 includes a tone-producing diaphragm 414 held on a forward portion 411B of an electrolarynx case 411 by means of a diaphragm-holding ring 415 having a case-engaging first portion 420, a diaphragm-engaging second portion 421, and a radially extending third portion 422 extending intermediate the first and second portions (i.e., a diaphragm-circumscribing member). The third portion 422 defines a double wave, extending radially between the first and second portions 320 and 321 along a first arc and then along a separate second arc.

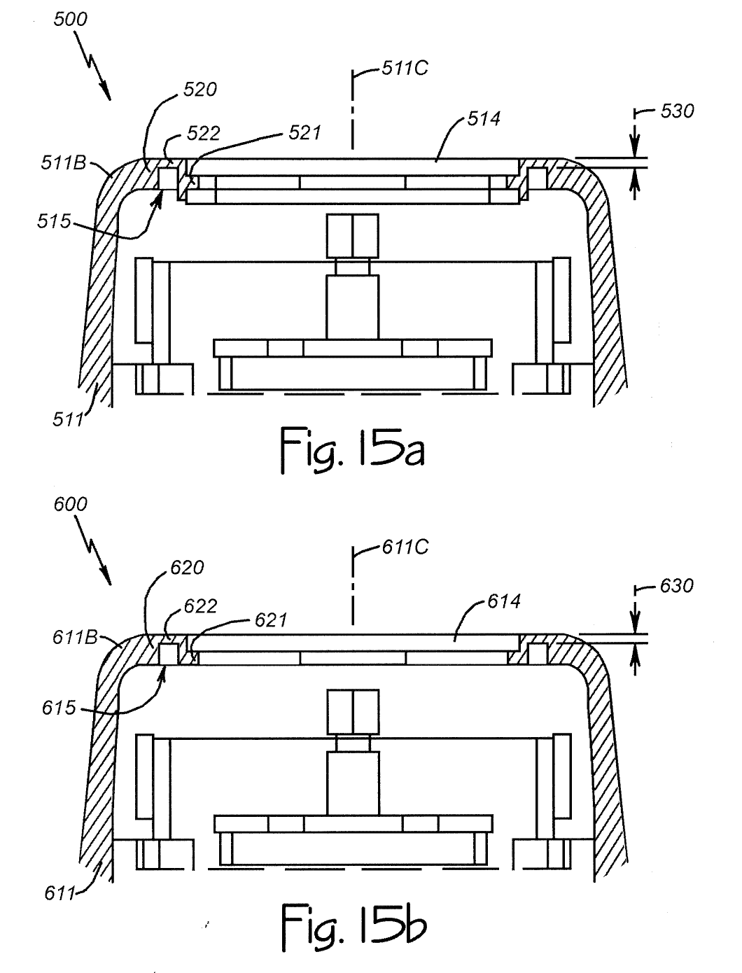

FIG. 15a shows molded one-piece construction with reference to an electrolarynx 500 having a tone-producing diaphragm 514 held by a diaphragm-holding ring 515 on a forward portion 511B of an electrolarynx case 511 having a central axis of elongation 511C. The tone-producing diaphragm 514 is similar to some existing tone-producing diaphragms. The diaphragm-holding ring 515, however, is constructed according to the broader inventive concepts of the present invention. It includes a case-engaging first portion 520, a diaphragm-engaging second portion 521, and a radially extending third portion 522 that is relatively thin and composed of an elastomer for improved tonal quality. The radially extending portion 522 may, for example, have a thickness lying in a range of about 0.010 inches to about 0.060 inches as indicated by a dimension 530 in FIG. 15a (preferably about 0.040 inches for a typical silicone rubber). Unlike the other embodiments described earlier, the case-engaging first portion 520 of the diaphragm-holding ring 515 (and thereby the rest of the diaphragm-holding ring 515) is molded in one-piece construction with the forward portion 511B of the case 511). Doing so can significantly facilitate fabrication and assembly of the electrolarynx 500.

FIG. 15b also shows molded one-piece construction. An electrolarynx 600 has a tone-producing diaphragm 614 held by a diaphragm-holding ring 615 on a forward portion 611B of an electrolarynx case 611 having a central axis of elongation 611C. The diaphragm-holding ring 615 is constructed according to the broader inventive concepts of the present invention, including a case-engaging first portion 620, a diaphragm-engaging second portion 621, and a radially extending third portion 622 that is relatively thin and composed of an elastomer for improved tonal quality. The radially extending portion 622 may, for example, have a thickness lying in a range of about 0.010 inches to about 0.060 inches as indicated by a dimension 630 in FIG. 15b (preferably about 0.040 inches for a typical silicone rubber). The major difference is that the tone-producing diaphragm 614 is thinner and lighter than the tone-producing diaphragm 514 shown in FIG. 15a. Based upon the foregoing and subsequent descriptions and the drawings, one of ordinary skill in the art can readily implement a “diaphragm-holding ring” composed of an elastomer according to the present invention.

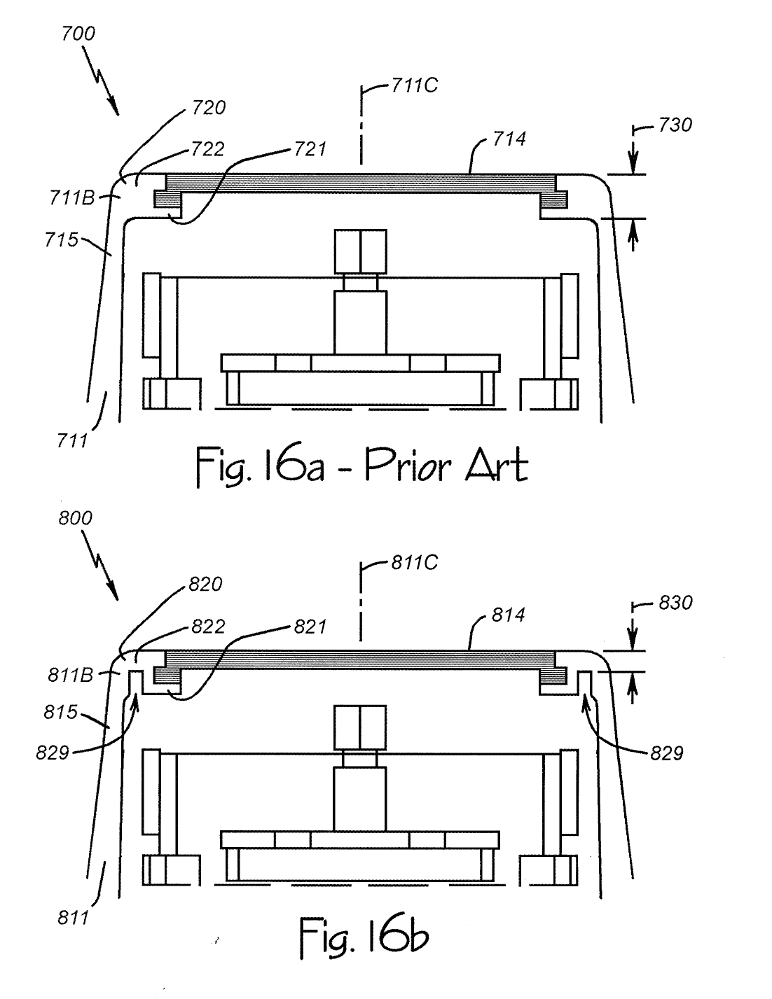

FIGS. 16a and 16b show two more embodiments. FIG. 16a shows a prior art embodiment (electrolarynx 700) having a relatively thick, and therefore relatively stiff, radially extending third portion that inhibits diaphragm movement. FIG. 16b shows an eighth embodiment constructed according to the present invention (an electrolarynx 800) having a groove that results in a relatively thin, and therefore more flexible, radially extending third portion for improved tonal quality. For convenience, those two embodiments will be described in using the alternate nomenclature developed above.

In terms of the alternate nomenclature developed above, the prior art electrolarynx 700 has a tone-producing diaphragm 714 held by a diaphragm-holding ring such that the diaphragm-holding ring is an integral part of an electrolarynx case 711 having a central axis of elongation 711C (FIG. 16a). The diaphragm-holding ring is molded or otherwise integrally formed with the case 711 to include a case-engaging first portion 720 that engages a forward portion 711B of the case 711, a diaphragm-engaging second portion 721 that engages a peripheral portion of the circular diaphragm 714, and a radially extending third portion 722 intermediate the first and second portions. The diaphragm-engaging second portion 721 is bonded to, or integrally formed with, a tone-producing diaphragm 714 so that the intermediate portion 722 of the diaphragm-holding ring is said to hold the diaphragm 714 moveably on the forward portion 711B of the case 711, for movement axially parallel to the central axis of elongation 711C. The electrolarynx 700 fails to function according to the invention, however, because the radially extending intermediate portion 722 is relative thick measured parallel to the central axis of elongation 711C. It is about 0.110 inches thick as indicated by a dimension 730 in FIG. 16a.

Similar to the prior art electrolarynx 700, and in terms of the alternate nomenclature, the electrolarynx 800 has a tone-producing diaphragm 814 held by a diaphragm-holding ring such that the diaphragm-holding ring is an integral part of an electrolarynx case 811 having a central axis of elongation 811C (FIG. 16b). The diaphragm-holding ring is an elastomer component that is molded or otherwise integrally formed with the case 811 to include a case-engaging first portion 820 that engages a forward portion 811B of the case 811, a diaphragm-engaging second portion 821 that engages a peripheral portion of the circular diaphragm 814, and a radially extending third portion 822 intermediate the first and second portions (i.e., a diaphragm-circumscribing member). The diaphragm-engaging second portion 821 is bonded to, or integrally formed with, a peripheral portion of a circular tone-producing diaphragm 814 so that the intermediate portion 822 of the diaphragm-holding ring is said to hold the diaphragm 814 moveably on the forward portion 811B of the case 811, for movement axially parallel to the central axis of elongation 811C.

Unlike the prior art electrolarynx 700, however, the electrolarynx 800 does function according to the invention because the radially extending intermediate portion 822 is relative thin measured parallel to the central axis of elongation 811C. An annular groove 929 results in a thickness of the radially extending intermediate portion 822 in a range of about 0.010 inches to about 0.060 inches, as indicated by a dimension 830 in FIG. 16b. The dimension 830 may vary according to the precise elastomer used, it being found that about 0.040 inches is preferable for a typical silicone rubber. Based upon the above and foregoing descriptions, one of ordinary skill in the art can readily implement an electrolarynx according to the invention.

Thus, the invention provides an electrolarynx having a tone-producing diaphragm that is supported movably on a forward portion of a case by a relative thin (e.g., 0.040-inch thick), radially extending, diaphragm-circumscribing, non-foam member composed of an elastomer to result in improved and more consistent audio quality, along with manufacturing/cost benefits and less tendency to accumulate dead skin, soil, saliva, food, and other particles. Although exemplary embodiments have been shown and described, one of ordinary skill in the art may make many changes, modifications, and substitutions without necessarily departing from the spirit and scope of the invention. As for the specific terminology used to describe the exemplary embodiments, it is not intended to limit the invention; each specific term is intended to include all technical equivalents that operate in a similar manner to accomplish a similar purpose or function. The expression “forward portion,” for example, refers to the distal end portion of the electrolarynx at which the electrolarynx tone is produced, and the expression “rearward portion” refers to the proximal end portion.

What is claimed is:

1. An electrolarynx, comprising:
a case having a forward portion, a rearward portion, and a central axis of elongation extending between the forward portion and rearward portion;
a tone-producing diaphragm on the forward portion of the case; and
means for holding the tone-producing diaphragm on the forward portion of the case so that the tone-producing diaphragm is free to move axially along the central axis of elongation in response to mechanical vibrations coupled to the tone-producing diaphragm from a diaphragm-driving subassembly disposed at least partially within the case;
wherein the means for holding the tone-producing diaphragm includes a radially extending member on the forward portion of the case that circumscribes and is connected to the tone-producing diaphragm; and
wherein the radially extending member is composed of an elastomer that resiliently deforms in response to movement of the diaphragm produced by the mechanical vibrations.

2. An electrolarynx as recited in claim 1, wherein the radially extending member has a thickness in a range of about 0.010 inches to about 0.060 inches.

3. An electrolarynx as recited in claim 1, wherein the radially extending member is integrally formed with the forward portion of the case.

4. An electrolarynx as recited in claim 1, wherein the radially extending member is part of a separate diaphragm-holding ring component disposed between the tone-producing diaphragm and the forward portion of the case.

5. An electrolarynx, comprising:
a case having a forward portion, a rearward portion, and a central axis of elongation extending between the forward portion and the rearward portion, said forward portion defining a diaphragm-receiving opening centered on the central axis of elongation and said forward portion including a radially inward facing annular surface;
a tone-producing diaphragm having a central axis of symmetry and a radially outward facing annular surface centered on the central axis of symmetry, said tone-producing diaphragm being disposed coaxially within the diaphragm-receiving opening on the forward portion of the case with the radially outward facing annular surface of the tone-producing diaphragm facing the radially inward facing annular surface on the forward portion of the case; and
means for holding the tone-producing diaphragm within the opening movably so that the tone-producing diaphragm is free to move axially along the central axis of elongation in response to mechanical vibrations coupled to the tone-producing diaphragm from a diaphragm-driving subassembly disposed at least partially within the case;
wherein the means for holding the tone-producing diaphragm includes a circularly shaped ring of material disposed intermediate the radially outward facing annular surface on the tone-producing diaphragm and the radially inward facing annular surface on the forward portion of the case; and
wherein the circularly shaped ring of material is at least partially composed of an elastomer that resiliently deforms in response to movement of the diaphragm produced by the mechanical vibrations.

6. An electrolarynx as recited in claim 5, wherein the elastomer is silicone.

7. An electrolarynx as recited in claim 5, wherein the ring is at least partially composed of a non-foam elastomer.

8. An electrolarynx as recited in claim 5, wherein the ring is shaped and dimensioned to replace a foam ring component for which the electrolarynx was originally designed.

9. An electrolarynx as recited in claim 8, wherein the ring includes a radially extending disc portion with an outer edge portion and a first thickness-increasing portion extending circumferentially along the outer edge portion.

10. An electrolarynx as recited in claim 9, wherein the radially extending disc portion includes an inner edge portion that defines a diaphragm-receiving opening and the ring includes a second thickness-increasing portion extending circumferentially along the inner edge portion.

11. An electrolarynx, comprising:
a case having a central axis of elongation and a forward portion defining a diaphragm-receiving opening centered on the central axis of elongation;
means on the forward portion of the case for producing a tone, including a tone-producing diaphragm having a central axis of symmetry, said tone-producing diaphragm being disposed coaxially within the diaphragm-receiving opening on the forward portion of the case so that the central axis of symmetry is coincident with the central axis of elongation; and
means for holding the tone-producing diaphragm within the diaphragm-receiving opening movably so that the tone-producing diaphragm is free to move axially along the central axis of elongation in response to mechanical vibrations coupled to the tone-producing diaphragm from a diaphragm-driving subassembly disposed at least partially within the case;
wherein the means for holding the tone-producing diaphragm includes a ring of material having a case-engaging first portion in engagement of the forward portion of the case, a diaphragm-engaging second portion in engagement of the tone-producing diaphragm, and a radially extending third portion intermediate the case-engaging first portion and the diaphragm-engaging second portion;
wherein the radially extending third portion is at least partially composed of an elastomer.

12. An electrolarynx as recited in claim 11, wherein the elastomer is silicone.

13. An electrolarynx as recited in claim 11, wherein the radially extending third portion has a thickness measured parallel to the axis of symmetry in the range of about 0.010 inches to about 0.050 inches.

14. An electrolarynx as recited in claim 11, wherein the radially extending third portion is composed of a non-foam elastomer.

15. An electrolarynx as recited in claim 11, wherein the radially extending third portion extends intermediate the case-engaging portion and the diaphragm-engaging portion along an arc.

16. An electrolarynx as recited in claim 11, wherein the radially extending third portion extends intermediate the case-engaging portion and the diaphragm-engaging portion along a plurality of arcs.

17. An electrolarynx as recited in claim 11, wherein the diaphragm-engaging second portion of ring of material and the tone-producing diaphragm are molded together in one-piece construction.
